(19) United States
(12) Patent Application Publication
(10) Pub. No.: US 2025/0233325 A1
(43) Pub. Date: Jul. 17, 2025

(54) WIRE SPLICE

(71) Applicant: TE Connectivity Solutions GmbH, Schaffhausen (CH)

(72) Inventors: Brian Keith Weaver, Middletown, PA (US); William James Moyer, II, Middletown, PA (US)

(21) Appl. No.: 18/413,104

(22) Filed: Jan. 16, 2024

(51) Int. Cl. H01R 4/20; H01R 4/72; H01R 43/20

(52) U.S. Cl. CPC H01R 4/20; H01R 4/72; H01R 43/20

(57) ABSTRACT

A wire splice assembly includes a wire splice having a wire splice terminal and a wire splice housing holding the wire splice terminal. The wire splice terminal includes a wire tube extending between a first end configured to receive an end of a first wire and a second end configured to receive an end of a second wire. The wire tube has crush barrels at the ends configured to crimp to the wires. The wire splice housing includes a cavity receiving the wire splice terminal. The wire splice housing includes a first funnel at a first end configured to guide the first wire to the first end of the wire splice terminal. The wire splice housing includes a second funnel at a second end configured to guide the second wire to the second end of the wire splice terminal. The wire spice assembly includes a carrier strip integral with the wire splice housing extending from the wire splice housing for connecting the wire splice housing to other wire splices. The wire splice housing is configured to be singulated from the carrier strip.

### BACKGROUND OF THE INVENTION

The subject matter herein relates generally to methods and devices for connecting together two wires at a wire splice.

Wire splices are used in electrical systems to facilitate secure and reliable interconnection of wires in various applications. Conventional wire splices often face challenges in their production and assembly processes, leading to inefficiencies and compromises in the overall performance of electrical systems. Existing methods and devices for wire splicing may involve intricate assembly steps, intricate tooling requirements, or limitations in accommodating a diverse range of wire types and sizes. These challenges impede the manufacturing process and compromise the integrity of the electrical connection. Some systems use hand tools to connect the wire splice product to the wires. Such assembly method is slow and labor intensive. Other systems use mass production machines to create spliced leads. However, the processes typically use loose piece splice elements that are difficult for harness makers to handle in high volume harness manufacturing. Some mass production methods use a tape to hold the splice elements together. However, production may be slowed due to improper positioning or handling of the tape and wire splice elements during the manufacturing process.

A need remains for a wire splice assembly for repeatable and efficient wire harness production.

### BRIEF DESCRIPTION OF THE INVENTION

In one embodiment, a wire splice assembly is provided and includes a wire splice that includes a wire splice terminal and a wire splice housing holding the wire splice terminal. The wire splice terminal includes a wire tube extends between a first end configured to receive an end of a first wire and a second end configured to receive an end of a second wire. The wire tube has a first crush barrel at the first end configured to crimp to the first wire. The wire tube has a second crush barrel at the second end configured to crimp to the second wire. The wire splice housing includes a cavity receiving the wire splice terminal. The wire splice housing includes a first funnel at a first end configured to guide the first wire to the first end of the wire splice terminal. The wire splice housing includes a second funnel at a second end configured to guide the second wire to the second end of the wire splice terminal. The wire spice assembly includes a carrier strip integral with the wire splice housing. The carrier strip extends from the wire splice housing for connecting the wire splice housing to other wire splices. The wire splice housing is configured to be singulated from the carrier strip.

In another embodiment, a wire splice assembly is provided and includes a wire splice that includes a wire splice terminal and a wire splice housing holding the wire splice terminal. The wire splice terminal includes a wire tube extends between a first end configured to receive an end of a first wire and a second end configured to receive an end of a second wire. The wire tube has a first crush barrel at the first end configured to crimp to the first wire. The wire tube has a second crush barrel at the second end configured to crimp to the second wire. The wire splice housing includes a cavity receiving the wire splice terminal. The wire splice housing includes a first funnel at a first end configured to guide the first wire to the first end of the wire splice terminal. The wire splice housing includes a second funnel at a second end configured to guide the second wire to the second end of the wire splice terminal. The wire spice assembly includes a first heat shrink sleeve coupled to the first end of the wire splice housing configured to be heat shrink applied to the first wire. The wire spice assembly includes a second heat shrink sleeve coupled to the second end of the wire splice housing configured to be heat shrink applied to the second wire. The wire spice assembly includes a carrier strip integral with the wire splice housing. The carrier strip extends from the wire splice housing for connecting the wire splice housing to other wire splices. The wire splice housing is configured to be singulated from the carrier strip.

In a further embodiment, a method of assembling a wire splice assembly is provided and includes providing a plurality of wire splice terminals. Each wire splice terminal includes a wire tube extends between a first end configured to receive an end of a first wire and a second end configured to receive an end of a second wire. The wire tube has a first crush barrel at the first end. The wire tube has a second crush barrel at the second end. The method provides a plurality of wire splice housings. Each wire splice housing includes a cavity receiving the wire splice terminal. The wire splice housing includes a first funnel at a first end. The wire splice housing includes a second funnel at a second end. The plurality of wire splice housings connected by a carrier strip molded integral with the wire splice housings. The method loads the wire splice terminals into the cavities of the corresponding wire splice housings.

### BRIEF DESCRIPTION OF THE DRAWINGS

FIG. 1 is a perspective view of a wire splice assembly in accordance with an exemplary embodiment.

FIG. 2 is a perspective view of the wire splice assembly in accordance with an exemplary embodiment.

FIG. 3 is a perspective view of the wire splice assembly in accordance with an exemplary embodiment showing a plurality of the wire splices arranged on a carrier strip.

FIG. 4 is a perspective view of the wire splice assembly showing the plurality of wire splices arranged on the carrier strip and having the heat shrink sleeves applied to the ends of the wire splices in accordance with an exemplary embodiment.

FIG. 5 is a perspective view of a plurality of the wire splice terminals in accordance with an exemplary embodiment.

FIG. 6 is a perspective view of a plurality of the wire splice housings in accordance with an exemplary embodiment.

FIG. 7 is a cross-sectional view of the wire splice assembly in accordance with an exemplary embodiment showing the wires electrically connected by the wire splice.

FIG. 8 is a cross-sectional view of the wire splice assembly in accordance with an exemplary embodiment showing the heat shrink sleeves attached to the wire splice housing.

FIG. 9 is a schematic view of a wire splice assembly process in accordance with an exemplary embodiment.

### DETAILED DESCRIPTION OF THE INVENTION

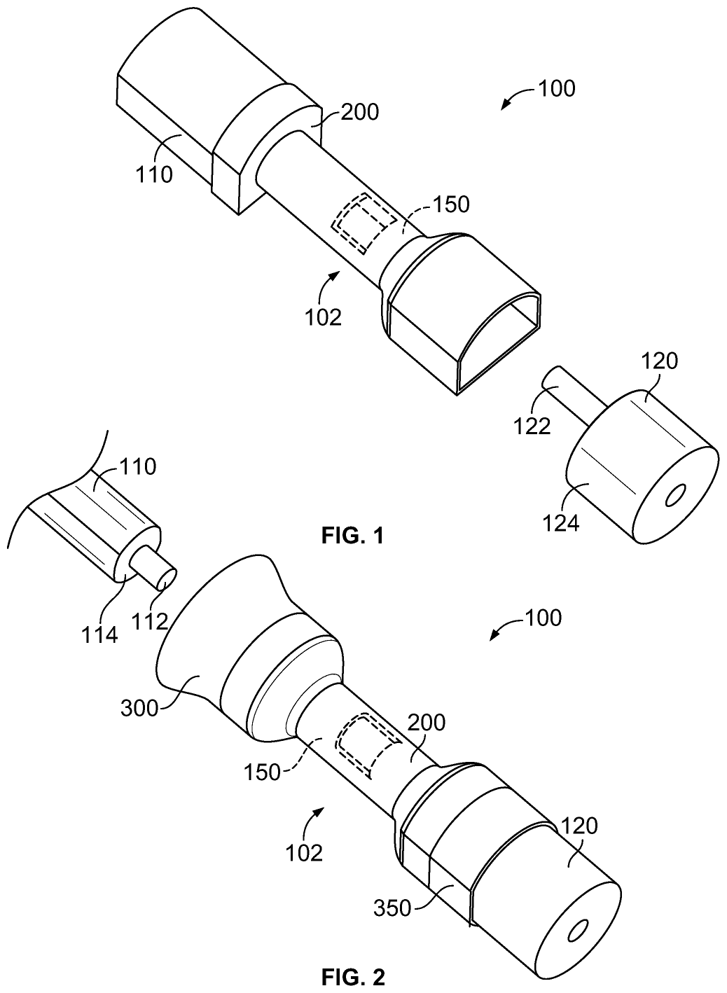

FIG. 1 is a perspective view of a wire splice assembly 100 in accordance with an exemplary embodiment. FIG. 2 is a perspective view of the wire splice assembly 100 in accordance with an exemplary embodiment. FIG. 2 shows the wire splice assembly 100 using heat shrink sleeves 300, 350 to provide moisture protection for the wire splice assembly 100. FIG. 1 shows the wire splice assembly 100 without the heat shrink sleeves 300, 350. The wire splice assembly 100 is used to facilitate secure and reliable connection between a first wire 110 and a second wire 120. The wire splice assembly 100 includes a wire splice 102 having a wire splice terminal 150 and a wire splice housing 200 holding the wire splice terminal 150. The wire splice terminal 150 is used to electrically connect the first and second wires 110, 120. The wire splice housing 200 provides an insulative cover for the connection between the wire splice terminal 150 and the wires 110, 120. FIG. 1 shows the first wire 110 coupled to the wire splice 102. FIG. 2 shows the second wire 120 coupled to the wire splice 102. During final assembly, both of the wires 110, 120 are coupled to the wire splice terminal 150.

The first wire 110 includes a first conductor 112 and a first insulator 114 surrounding the first conductor 112. The first conductor 112 may be a solid wire or a stranded wire. The first insulator 114 may be extruded over the first conductor 112. In various embodiments, the first wire 110 may be a small gauge wire, such as 10-12 AWG. In other various embodiments, the first wire 110 may be a large gauge wire, such as 22-26 AWG. In other various embodiments, the first wire 110 may be a medium gauge wire, such as 14-16 AWG or 18-22AWG. In an exemplary embodiment, different sides wire splice assemblies 100 may be provided to handle the different wire sizes.

The second wire 120 includes a second conductor 122 and a second insulator 124 surrounding the second conductor 122. The second conductor 122 may be a solid wire or a stranded wire. The second insulator 124 may be extruded over the second conductor 122. Optionally, the second wire 120 may be the same size as the first wire 110. However, in other embodiments, the wire splice 102 may accommodate splicing different size wires. In various embodiments, the second wire 120 may be a small gauge wire, such as 10-12 AWG. In other various embodiments, the second wire 120 may be a large gauge wire, such as 22-26 AWG. In other various embodiments, the second wire 120 may be a medium gauge wire, such as 14-16 AWG or 18-22AWG. In an exemplary embodiment, different sides wire splice assemblies 100 may be provided to handle the different wire sizes.

During manufacture, when the first and second wires 110, 120 are inserted into the opposite ends of the wire splice 102, the wire splice terminal 150 may be crimped or otherwise squeezed or compressed to create a compressive connection between the wire splice terminal 150 and the first and second wires 110, 120. The wire splice housing 200 is flexible to allow the crimping or compression of the wire splice terminal 150. The wire splice 102 may be applied to the ends of the wires 110, 120 using a hand tool, such as a crimping tool. In alternative embodiments, the wire splice 102 may be applied to the ends of the wires 110, 120 by a machine, such as an applicator, crimping machine, or lead maker, such as for high volume wire harness production.

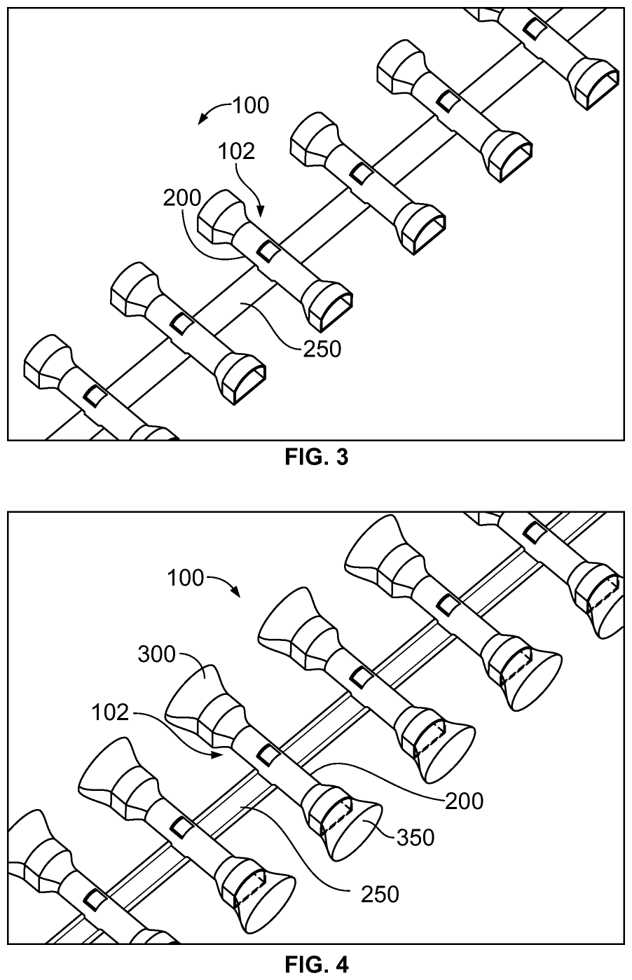

FIG. 3 is a perspective view of the wire splice assembly 100 in accordance with an exemplary embodiment showing a plurality of the wire splices 102 arranged on a carrier strip 250. FIG. 4 is a perspective view of the wire splice assembly 100 showing the plurality of wire splices 102 arranged on the carrier strip 250 and having the heat shrink sleeves 300, 350 applied to the ends of the wire splices 102.

The carrier strip 250 holds the wire splices 102 in a chain to allow for easier manufacturability and material handling, such as for high volume harness production. The carrier strip 250 holds the wire splices 102 at predetermined spacing from each other. In an exemplary embodiment, the carrier strip 250 and the wire splices 102 may be wound up on a reel for shipping and handling during manufacture. The carrier strip 250 is used to deliver the wire splices 102 through one or more processing machines during manufacture.

In an exemplary embodiment, the wire splice housings 200 are formed integral with the carrier strip 250 during a common manufacturing process. For example, the wire splice housings 200 may be co-molded with the carrier strip 250 during a common molding process to ensure reliable positioning and retention of the wire splice housings 200 for processing during manufacture. The carrier strip 250 is manufactured from the same material as the wire splice housings 200, such as a plastic material. For example, the carrier strip 250 and the wire splice housings 200 are a unitary monolithic structure.

In an exemplary embodiment, the carrier strip 250 may be approximately centered relative to the wire splice housings 200. For example, the carrier strip 250 is approximately centered between the opposite ends of the wire splice housings 200. The carrier strip 250 may be located at the bottom of the wire splice housings 200. In an exemplary embodiment, the wire splice housings 200 are configured to be singulated from the carrier strip 250, such as by cutting or otherwise separating, the wire splice housings 200 from the carrier strip 250.

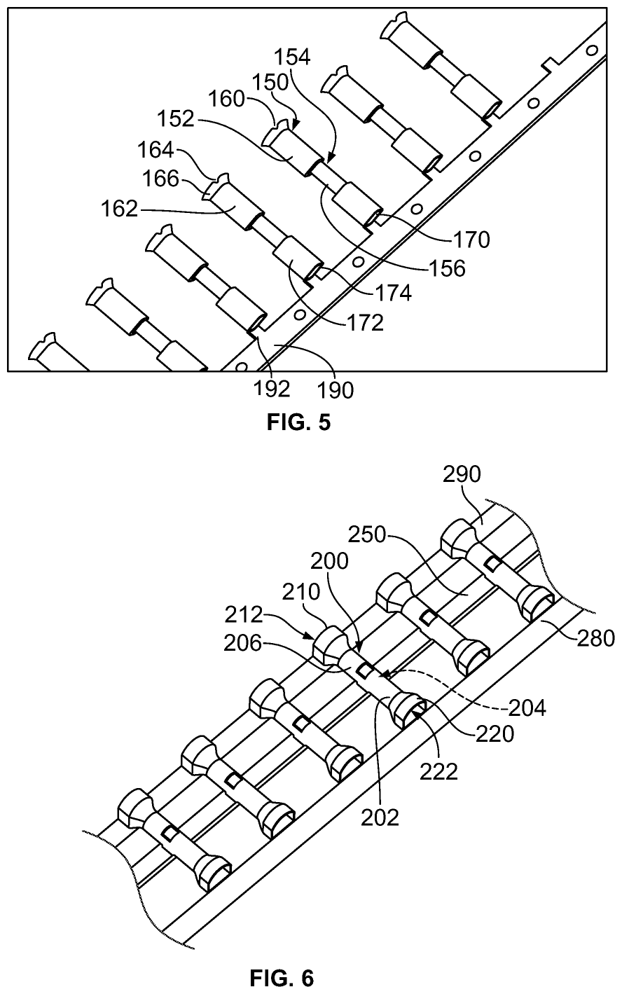

FIG. 5 is a perspective view of a plurality of the wire splice terminals 150 in accordance with an exemplary embodiment. In an exemplary embodiment, the wire splice terminals 150 are stamped and formed terminals. For example, the wire splice terminals 150 may be stamped from a metal blank or sheet and formed into a generally cylindrical shape. For example, ends of the stamped terminal may be bent or rolled into a tubular shape.

In an exemplary embodiment, a plurality of the wire splice terminals 150 are held together by a terminal carrier strip 190. The terminal carrier strip 190 may be stamped with the wire splice terminals 150. The terminal carrier strip 190 holds the wire splice terminals 150 at predetermined positions relative to each other for loading into a machine, such as a terminal insertion machine used to insert the wire splice terminals 150 into the wire splice housings 200. The wire splice terminals 150 may be singulated from the terminal carrier strip 190 by the machine, for example as the wire splice terminal 150 is loaded into the wire splice housing 200.

Each wire splice terminal 150 includes a wire tube 152 extending between a first end 160 and a second end 170. The wire tube 152 is configured to receive the first wire 110 at the first end 160 and the second wire 120 at the second end 170. In an exemplary embodiment, the second end 170 is connected to the carrier strip 190, such as using a connecting tab 192. The connecting tab 192 may be cut or otherwise separated from the wire splice terminal 150 when the wire splice terminal 150 is singulated from the carrier strip 190.

In an exemplary embodiment, the wire tube 152 includes a window 154, which may be approximately centered between the first end 160 and the second end 170. The window 154 may be used for visual inspection, such as to confirm that the ends of the wires 110, 120 are fully loaded into the wire tube 152. The window 154 may provide a space for material to flow during the crimping process wherein the wire tube 152 is crimped to the conductors of the wires 110, 120. The wire tube 152 includes a connecting rail 156 below the window 154. The connecting rail 156 connects the portions of the wire tube 152 on opposite sides of the window 154.

The wire tube 152 includes a first crush barrel 162 at the first end 160. The first crush barrel 162 is configured to be crimped onto the end of the first wire 110. The first crush barrel 162 extends between the window 154 and a first edge 164 of the wire tube 152 at the first end 160. In an exemplary embodiment, the first end 160 of the wire tube 152 is flared outward at the first edge 164. For example, the wire tube 152 is an enlarged at the first end 160. In an exemplary embodiment, the wire tube 152 forms a terminal funnel 166 at the first end 160. The terminal funnel 166 is used to guide the end of the first wire 110 into the wire tube 152. The flared portion of the wire tube 152 at the first end 160 may be used to locate the wire splice terminal 150 in the wire splice housing 200, such as to restrict or limit loading of the wire splice terminal 150 into the wire splice housing 200.

The wire tube 152 includes a second crush barrel 172 at the second end 170. The second crush barrel 172 is configured to be crimped onto the end of the second wire 120. The second crush barrel 172 extends between the window 154 and a second edge 174 of the wire tube 152 at the second end 170. In an exemplary embodiment, the wire tube 152 is generally cylindrical having a constant diameter along the second end 170 as opposed to being flared outward like the first end 160. As such, the second end 170 of the wire tube 152 may be readily loaded into the wire splice housing 200. In alternative embodiments, the first end 160 may be similar to the second end 170, such as being devoid of the flared portion forming the terminal funnel 166. In other alternative embodiments, the second end 170 may include a flared portion forming a terminal funnel (not shown) at the second end 170.

FIG. 6 is a perspective view of a plurality of the wire splice housings 200 in accordance with an exemplary embodiment. In an exemplary embodiment, the wire splice housings 200 molded parts. The wire splice housings 200 may be co-molded with each other, such as with the carrier strip 250 and molding strips 280, 290 at opposite ends of the wire splice housings 200. During the molding process, the molding material (for example, plastic) is able to flow between the wire splice housings 200 through the carrier strip 250 and the molding strips 280, 290. The carrier strip 250 and the molding strips 280, 290 position the wire splice housings 200 relative to each other. In an exemplary embodiment, the molding strips 280, 290 are removed for separated from the wire splice housings 200 during a removal process, leaving behind the wire splice housings 200 on the carrier strip 250, which may be wound up on a reel for transportation and dispensing during later manufacturing processes.

Each wire splice housing 200 includes a housing body 202 forming a cavity 204 extending between a first end 210 and a second end 220 of the wire splice housing 200. The cavity 204 is configured to receive the wire splice terminal 150. The cavity 204 is open at the first end 210 to receive the first wire 110 and at the second end 220 to receive the second wire 120. In an exemplary embodiment, the first end 210 is open to receive the wire splice terminal 150 during assembly. However, the wire splice terminal 150 may be loaded into the second end 220 in alternative embodiments. In an exemplary embodiment, the housing body 202 is generally tubular shaped. For example, the housing body 202 may be cylindrical. In other various embodiments, the housing body 202 may have one or more flat surfaces, such as a flat surface along the bottom and/or the top and/or the sides.

In an exemplary embodiment, the wire splice housing 200 includes a first funnel 212 at the first end 210. The first funnel 212 is used to guide the end of the first wire 110 into the cavity 204. The first funnel 212 may be enlarged relative to a central portion 206 of the housing body 202. The first funnel 212 is enlarged to provide a larger opening to receive the end of the first wire 110. The first funnel 212 may taper inward to the cavity 204 to guide the first wire 110 into the wire splice terminal 150 held in the cavity 204. In an exemplary embodiment, the first heat shrink sleeves 300 (FIG. 4) may be applied to the first funnel 212.

In an exemplary embodiment, the wire splice housing 200 includes a second funnel 222 at the second end 220. The second funnel 222 is used to guide the end of the second wire 120 into the cavity 204. The second funnel 222 may be enlarged relative to a central portion 206 of the housing body 202. The second funnel 222 is enlarged to provide a larger opening to receive the end of the second wire 120. The second funnel 222 may taper inward to the cavity 204 to guide the second wire 120 into the wire splice terminal 150 held in the cavity 204. In an exemplary embodiment, the second heat shrink sleeves 350 (FIG. 4) may be applied to the second funnel 222.

In an exemplary embodiment, the carrier strip 250 extends from the sides of the central portion 206. The carrier strip 250 may be approximately centered between the first and second funnel 212, 222. For example, the carrier strip 250 may be spaced apart from the first funnel 212 and spaced apart from the second funnel 222. In an exemplary embodiment, the wire splice housings 200 span across the carrier strip 250. For example, the carrier strip 250 is oriented perpendicular to the central portions 206 of the wire splice housings 200. In an exemplary embodiment, the carrier strip 250 extends across the bottom of the wire splice housings 200. For example, the carrier strip 250 may be continuous with the central portions 206 of the wire splice housings 200 located above the carrier strip 250. Optionally, the wire splice housings 200 may be singulated from the carrier strip 250 by making a horizontal cut between the wire splice housings 200 and the carrier strip 250 leaving the carrier strip 250 intact to continue to pull the wire splice housings through the manufacturing machines. However, in other embodiments, the wire splice housings 200 may be singulated from the carrier strip 250 by making vertical cuts between the wire splice housings 200 and the carrier strip 250 along the sides of the central portion 206.

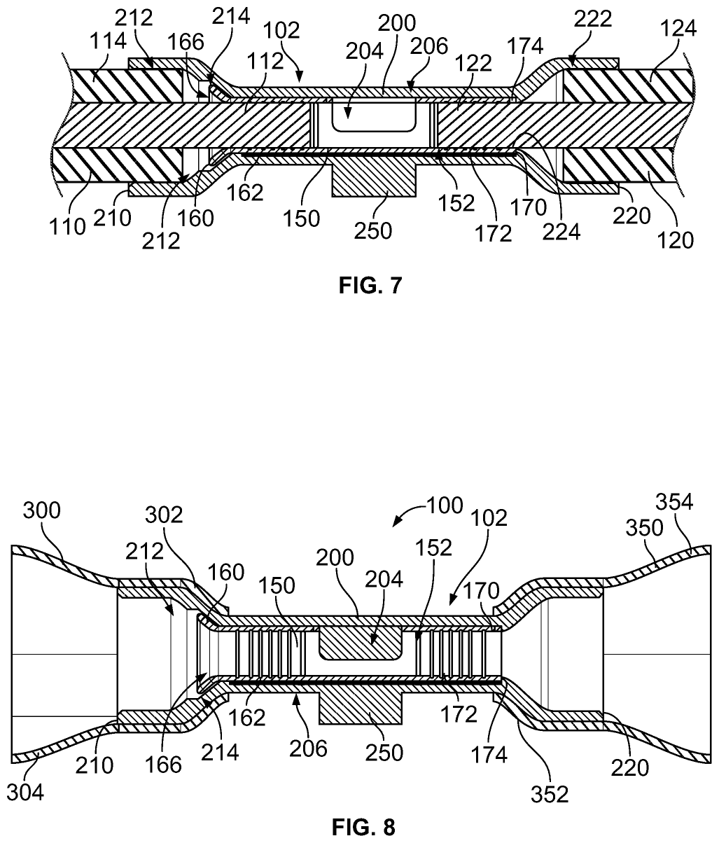

FIG. 7 is a cross-sectional view of the wire splice assembly 100 in accordance with an exemplary embodiment showing the wires 110, 120 electrically connected by the wire splice 102. FIG. 8 is a cross-sectional view of the wire splice assembly 100 in accordance with an exemplary embodiment showing the heat shrink sleeves 300, 350 attached to the wire splice housing 200. The wires 110, 120 are removed in FIG. 8 to illustrate the components of the wire splice 102.

In an exemplary embodiment, the heat shrink sleeves 300, 350 are attached to the first and second ends 210, 220 of the wire splice housing 200, respectively. In an exemplary embodiment, the first heat shrink sleeve 300 is separate and discrete from the second heat shrink sleeve 350. For example, the wire splice 102 does not include a single heat shrink sleeve spanning across the entire wire splice 102. For example, because the carrier strip 250 extends from both sides of the wire splice housing 200, it may not be possible to use a single heat shrink sleeve on the wire splice 102. Additionally, it may be undesirable to provide the heat shrink sleeves 300, 350 on the portions of the wire splice housing 200 associated with the crush barrels 162, 172. For example, the crimp tooling may damage or tear heat shrink sleeve material that covers such portions of the wire splice housing 200, which may cause the heat shrink sleeve material to attach or otherwise obstruct proper operation of the crimp tooling.

In an exemplary embodiment, the first heat shrink sleeve 300 includes a housing attachment end 302 and a wire attachment end 304. The housing attachment end 302 is attached to the wire splice housing 200. For example, the housing attachment end 302 is attached to the first funnel 212. In an exemplary embodiment, an inner surface of the heat shrink sleeve 300 at the housing attachment end 302 includes an adhesive layer to secure the housing attachment end 302 to the first funnel 212. The housing attachment end 302 may be attached to the wire splice housing 200 by the application of heat during a heat shrink application. The housing attachment end 302 may form a moisture barrier between the heat shrink sleeve 300 and the wire splice housing 200. In an exemplary embodiment, the wire attachment end 304 is shielded from the application of heat when attaching the housing attachment end 302 to the first funnel 212. As such, the wire attachment end 304 does not shrink inward when the housing attachment end 302 is attached to the wire splice housing 200. Rather, the wire attachment end 304 remains flared outward to form a large gathering space for loading the first wire 110 into the wire splice 102. After the wire splice 102 is terminated to the first wire 110, the wire attachment end 304 of the first heat shrink sleeve 300 may be attached to the outer surface of the insulator 114 of the first wire 110. For example, heat may be applied to the wire attachment end 304 during a heat shrink application causing the wire attachment end 304 to shrink inward and attached to the insulator 114. The wire attachment end 304 may form a moisture barrier between the heat shrink sleeve 300 and the first wire 110.

In an exemplary embodiment, the second heat shrink sleeve 350 includes a housing attachment end 352 and a wire attachment end 354. The housing attachment end 352 is attached to the wire splice housing 200. For example, the housing attachment end 352 is attached to the second funnel 222. In an exemplary embodiment, an inner surface of the heat shrink sleeve 350 at the housing attachment end 352 includes an adhesive layer to secure the housing attachment end 352 to the second funnel 222. The housing attachment end 352 may be attached to the wire splice housing 200 by the application of heat during a heat shrink application. The housing attachment end 352 may form a moisture barrier between the heat shrink sleeve 350 and the wire splice housing 200. In an exemplary embodiment, the wire attachment end 354 is shielded from the application of heat when attaching the housing attachment end 352 to the second funnel 222. As such, the wire attachment end 354 does not shrink inward when the housing attachment end 352 is attached to the wire splice housing 200. Rather, the wire attachment end 354 remains flared outward to form a large gathering space for loading the second wire 120 into the wire splice 102. After the wire splice 102 is terminated to the second wire 120, the wire attachment end 354 of the second heat shrink sleeve 350 may be attached to the outer surface of the insulator 124 of the second wire 120. For example, heat may be applied to the wire attachment end 354 during a heat shrink application causing the wire attachment end 354 to shrink inward and attached to the insulator 124. The wire attachment end 354 may form a moisture barrier between the heat shrink sleeve 350 and the second wire 120.

The wire splice housing 200 holds the wire splice terminal 150. The wire splice housing 200 is manufactured from an insulating material to insulate around the wire splice terminal 150 and the wires 110, 120. The heat shrink sleeves 300, 350 are configured to be heat shrink applied to the wires 110, 120 to provide moisture protection for the electrical connection. The wire splice 102 may be utilized with or without the heat shrink sleeves 300, 350 depending on the particular application and end use of the wire harness.

During assembly, the wire splice terminal 150 is loaded into the cavity 204 of the wire splice housing 200. For example, the second end 170 of the wire splice terminal 150 is loaded into the opening in the wire splice housing 200 at the first end 210 of the wire splice housing 200. The first funnel 212 may be used to guide the second end 170 of the wire splice terminal 150 into the cavity 204. In an exemplary embodiment, an inner diameter of the wire splice housing 200 is approximately equal to an outer diameter of the wire tube 152 such that the wire splice terminal 150 is held snugly in the cavity 204. The wire splice terminal 150 may be held in the cavity 204 by an interference fit.

In an exemplary embodiment, the wire splice housing 200 includes a locating lip 224 at the second end 220. The second edge 174 of the wire splice terminal 150 at the second end 170 is configured to abut against the locating lip 224 when the wire splice terminal 150 is loaded into the cavity 204. The locating lip 224 is used to locate the wire splice terminal 150 in the cavity 204. The locating lip 224 restricts movement of the wire splice terminal 150 beyond the locating lip 224. For example, the locating lip 224 prevents overloading of the wire splice terminal 150 in the cavity 204. The locating lip 224 positions the second crush barrel 172 in the central portion 206 of the wire splice housing 200.

In an exemplary embodiment, the wire splice housing 200 includes a funnel pocket 214 at the first end 210. The funnel pocket 214 receives the terminal funnel 166 at the first end 160 of the wire splice terminal 150. In an exemplary embodiment, the wire splice terminal 150 has an enlarged diameter at the terminal funnel 166. The enlarged diameter is larger than the inner diameter of the cavity 204 of the wire splice housing 200 to prevent loading of the terminal funnel 166 into the central portion 206 of the wire splice housing 200. The terminal funnel 166 bottoms out against the wire splice housing 200 in the funnel pocket 214 to prevent overloading of the wire splice terminal 150 into the cavity 204. The terminal funnel 166 and the funnel pocket 214 are used to position the wire splice terminal 150 in the wire splice housing 200, such as to align the first crush barrel 162 with the central portion 206 of the wire splice housing 200.

During assembly, the end of the first wire 110 is loaded into the first end of the wire splice 102. For example, the first funnel 212 receives the end of the first wire 110. The first funnel 212 guides the end of the conductor 112 of the first wire 110 into the wire splice terminal 150. The first funnel 212 provides lead-in for the first wire 110 into the wire splice terminal 150. In an exemplary embodiment, the terminal funnel 166 of the wire splice terminal 150 guides the conductor 112 of the first wire 110 into the first crush barrel 162. The terminal funnel 166 provides lead-in for the first conductor 112 into the first crush barrel 162. The first crush barrel 162 may be crimped to the first conductor 112 after the first wire 110 is loaded into the wire splice 102. In an exemplary embodiment, the material of the wire splice housing 200 is compliant to allow the crimp tooling to compress the wire splice housing 200 enough to crush the first crush barrel 162 to terminate the wire splice 102 to the first wire 110.

During assembly, the end of the second wire 120 is loaded into the second end of the wire splice 102. For example, the second funnel 222 receives the end of the second wire 120. The second funnel 222 guides the end of the conductor 122 of the second wire 120 into the wire splice terminal 150. The second funnel 222 provides lead-in for the second wire 120 into the second crush barrel 172 of the wire splice terminal 150. The second crush barrel 172 may be crimped to the second conductor 122 after the second wire 120 is loaded into the wire splice 102. In an exemplary embodiment, the material of the wire splice housing 200 is compliant to allow the crimp tooling to compress the wire splice housing 200 enough to crush the second crush barrel 172 to terminate the wire splice 102 to the second wire 120.

In an exemplary embodiment, during manufacture, the wire splice 102 is separated from the carrier strip 250. The wire splice 102 may be separated from the carrier strip 250 after the wires 110, 120 are loaded into the wire splice 102 and/or after the wire splice 102 is terminated to the ends of the wires 110, 120, such as after the crimping process.

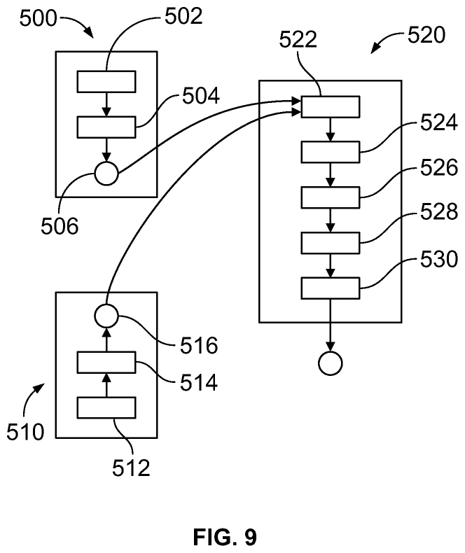

FIG. 9 is a schematic view of a wire splice assembly process in accordance with an exemplary embodiment. In an exemplary method of forming wire harnesses from wire splice assemblies is described with reference to FIG. 9. The method may include additional processes or steps in alternative embodiments. Processes or steps described herein may be omitted in other various embodiments.

In an exemplary embodiment, a wire splice terminal forming machine 500 is provided for forming wire splice terminals. A wire splice housing forming machine 510 is provided for forming wire splice housings. An assembly machine 520 is provided for assembling the wire splice terminals and the wire splice housings to connect wires to form a wire harness.

The wire splice terminal forming machine 500 includes a stamping machine 502, a forming machine 504, and a reel machine 506. The wire splice terminals are stamped from a metal sheet at the stamping machine 502. In an exemplary embodiment, the wire splice terminals are arranged on a terminal carrier strip that is stamped with the wire splice terminals at the stamping machine 502. The wire splice terminals are formed into a predetermined shape at the forming machine 504. For example, the wire splice terminals are formed into a generally tubular shape. Optionally, one or both ends may be flared outward to form a terminal funnel used to guide ends of the wires into the wire tube of the wire splice terminal. The wire splice terminals and the terminal carrier strip are wound up on a reel by the reel machine 506. The terminal carrier strip allows the product to be wound up on a reel at the reel machine 506 for transport, handling, and/or further processing.

The wire splice housing forming machine 510 includes a molding machine 512, a heat shrink sleeve application machine 514, and a reel machine 516. The wire splice housings are formed at the molding machine 512. For example, the wire splice housings may be injection molded at the molding machine 512. In an exemplary embodiment, the wire splice housings are molded with a carrier strip as an integral, unitary structure. The wire splice housings are formed to include a cavity sized and shaped to receive the wire splice terminals. Optionally, the ends of the wire splice housings may receive heat shrink sleeves attached thereto at the heat shrink sleeve application machine 514. The wire splice housings and the carrier strip are wound up on a reel by the reel machine 516 for transport, handling, and/or further processing.

Both the real including the wire splice terminals and the real including the wire splice housings are presented to the assembly machine 520. The assembly machine 520 includes a terminal loading machine 522, one or more wire loading machines 524, one or more crimping machines 526, one or more heat shrink application machines 528, and a carrier strip removal machine 530. The wire splice terminals are loaded into the wire splice housings at the terminal loading machine 522. For example, the wire splice terminals are singulated from the terminal carrier strip and inserted into the cavity of the wire splice housing at the end of the wire splice housing. Ends of the wires are loaded into the wire splice by the wire loading machines 524. The wire splice is terminated to the ends of the wires by the crimping machines 526. When the heat shrink sleeves are utilized, the heat shrink application machines 528 apply the heat shrink sleeves to the wires. The wire splices are removed from the carrier strip by the carrier strip removal machine 530. For example, the wire splices may be cut from the carrier strip to singulate the wire harness with the wire splice connecting the wires of the wire harness. The wire harness may be further processed by other machines.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

What is claimed is:

1. A wire splice assembly comprising:
a wire splice including a wire splice terminal and a wire splice housing holding the wire splice terminal, the wire splice terminal including a wire tube extending between a first end configured to receive an end of a first wire and a second end configured to receive an end of a second wire, the wire tube having a first crush barrel at the first end configured to crimp to the first wire, the wire tube having a second crush barrel at the second end configured to crimp to the second wire, the wire splice housing including a cavity receiving the wire splice terminal, the wire splice housing including a first funnel at a first end configured to guide the first wire to the first end of the wire splice terminal, the wire splice housing including a second funnel at a second end configured to guide the second wire to the second end of the wire splice terminal; and
a carrier strip integral with the wire splice housing, the carrier strip extending from the wire splice housing for connecting the wire splice housing to other wire splices, wherein the wire splice housing is configured to be singulated from the carrier strip.

2. The wire splice assembly of claim 1, wherein the carrier strip and the wire splice housing are a unitary monolithic structure.

3. The wire splice assembly of claim 1, wherein the carrier strip is located between the first and second ends of the wire splice housing.

4. The wire splice assembly of claim 1, wherein the carrier strip is approximately centered along the wire splice housing between the first and second ends.

5. The wire splice assembly of claim 1, wherein the carrier strip is located at a bottom of the wire splice housing.

6. The wire splice assembly of claim 1, wherein the wire splice is configured to be wound on a reel with the carrier strip in the other wire splices.

7. The wire splice assembly of claim 1, wherein the wire splice terminal includes a terminal lead-in at the first end forming a terminal funnel configured to guide the first wire into the first crush barrel.

8. The wire splice assembly of claim 1, wherein the wire splice housing includes a locating lip, the second end of the wire splice terminal engaging the locating lip to locate the wire splice terminal in the cavity.

9. The wire splice assembly of claim 1, wherein the first funnel has a first funnel diameter, the second funnel has a second funnel diameter, in the cavity has a cavity diameter less than the first and second funnel diameters, the second end of the wire terminal having a diameter less than the cavity diameter to load the wire tube of the wire splice terminal into the cavity, the first end of the wire tube being flared outward forming and in large diameter greater than the cavity diameter to restrict the first end from entering the cavity.

10. The wire splice assembly of claim 1, further comprising a first heat shrink sleeve coupled to the first end of the wire splice housing configured to be heat shrink applied to the first wire and a second heat shrink sleeve coupled to the second end of the wire splice housing configured to be heat shrink applied to the second wire.

11. A wire splice assembly comprising:
a wire splice including a wire splice terminal and a wire splice housing holding the wire splice terminal, the wire splice terminal including a wire tube extending between a first end configured to receive an end of a first wire and a second end configured to receive an end of a second wire, the wire tube having a first crush barrel at the first end configured to crimp to the first wire, the wire tube having a second crush barrel at the second end configured to crimp to the second wire, the wire splice housing including a cavity receiving the wire splice terminal, the wire splice housing including a first funnel at a first end configured to guide the first wire to the first end of the wire splice terminal, the wire splice housing including a second funnel at a second end configured to guide the second wire to the second end of the wire splice terminal;
a first heat shrink sleeve coupled to the first end of the wire splice housing configured to be heat shrink applied to the first wire;
a second heat shrink sleeve coupled to the second end of the wire splice housing configured to be heat shrink applied to the second wire; and
a carrier strip integral with the wire splice housing, the carrier strip extending from the wire splice housing for connecting the wire splice housing to other wire splices, wherein the wire splice housing is configured to be singulated from the carrier strip.

12. The wire splice assembly of claim 11, wherein the first heat shrink sleeve includes a first housing attachment end attached to the wire splice housing and a first wire attachment end extending beyond the first end of the wire splice housing configured to be attached to the first wire, the second heat shrink sleeve including a second housing attachment end attached to the wire splice housing and a second wire attachment end extending beyond the second end of the wire splice housing configured to be attached to the second wire.

13. The wire splice assembly of claim 11, wherein the first heat shrink sleeve is separate and discrete from the second heat shrink sleeve, the first heat shrink sleeve being spaced apart from the second heat shrink sleeve.

14. The wire splice assembly of claim 11, wherein the carrier strip is located between the first heat shrink sleeve and the second heat shrink sleeve.

15. The wire splice assembly of claim 11, wherein the first heat shrink sleeve is coupled to the first funnel remote from the portion of the wire splice housing holding the first crush barrel, and wherein the second heat shrink sleeve is coupled to the second funnel remote from the portion of the wire splice housing holding the second crush barrel.

16. A method of assembling a wire splice assembly comprising:
providing a plurality of wire splice terminals, each wire splice terminal including a wire tube extending between a first end configured to receive an end of a first wire and a second end configured to receive an end of a second wire, the wire tube having a first crush barrel at the first end, the wire tube having a second crush barrel at the second end;
providing a plurality of wire splice housings, each wire splice housing including a cavity receiving the wire splice terminal, the wire splice housing including a first funnel at a first end, the wire splice housing including a second funnel at a second end, the plurality of wire splice housings connected by a carrier strip molded integral with the wire splice housings;
loading the wire splice terminals into the cavities of the corresponding wire splice housings.

17. The method of claim 16, wherein said providing the plurality of the wire splice terminals include providing the wire splice terminals on a terminal carrier, the method further comprising singulating the wire splice terminals from the terminal carrier prior to loading the wire splice terminals into the cavities of the corresponding wire splice housings.

18. The method of claim 16, further comprising singulating the wire splice housings from the carrier strip after the wire splice terminals are loaded into the corresponding wire splice housings.

19. The method of claim 16, further comprising attaching a first heat shrink sleeve to the first end of the wire splice housing and attaching a second heat shrink sleeve to the second end of the wire splice housing.

20. The method of claim 16, wherein said providing a plurality of the wire splice housings connected to the carrier strip includes co-molding the carrier strip with a plurality of the wire splice housings.
